(19) United States
(12) Patent Application Publication
(10) Pub. No.: US 2003/0096642 A1
(43) Pub. Date: May 22, 2003

(54) Case for cellular phone

(76) Inventors: Jerry Bessa, Ojai, CA (US); Omkarnath K. Gupta, Ventura, CA (US); Robert Schilken, Ventura, CA (US); Mark Kollman, Oxnard, CA (US)

Correspondence Address: Michael G. Petit, P.O. Box 91929, Santa Barbara, CA, 93190-1929, US

(21) Appl. No.: 10/054,804

(22) Filed: Nov. 19, 2001

(51) Int. Cl. H04M 1/00

(52) U.S. Cl. 455/573; 455/572; 455/550

(57) ABSTRACT

A case or holster for the storage and transport of a cellular phone or similar battery powered communication device. The holster is adapted to be attached to and worn upon a person's body. The holster includes at least one photovoltaic element and circuitry that, in combination, enables solar energy to be used to charge a battery within the phone when the phone is disposed within the holster. The holster further includes a tilt-adjustable clip providing a means for tilting the holster with respect to the point of attachment of the clip to the wearer. The tiltable mount enables the orientation of the photovoltaic cell affixed to the surface of the holster to be varied with respect to the position of the sun in order to optimize the intensity of solar energy incident thereon. The holster includes a charging circuit and battery pack that is in electrical connection with the internal battery and charging circuitry of the phone when the phone is disposed within the holster. An LED array on the exterior surface of the holster indicates the insolation and the status of the solar charging circuitry within the holster. The charging circuit provides optimum power transfer from the photovoltaic element(s) to a secondary battery within the charging circuitry housed within the holster. In a second embodiment, a tilt-adjustable solar reflector, mounted on the holster, is employed to increase the intensity of light incident upon the photovoltaic element.

### BACKGROUND OF THE INVENTION

1. Field of the Invention

The present invention relates generally to a holster for storing an electronic device having a rechargeable battery and more particularly, to a holster adapted to receive and store a cellular phone and employ solar energy to charge the phone's on-board battery when the phone is disposed within the holster.

2. Prior Art

Various holsters for cellular phones are well known in the art and are, for the most part, obvious, being designed to store and protect a cellular phone during periods of disuse. Most, if not all, such prior art holsters provide the user with ready access to the phone, while protecting the delicate device during disuse. Such prior art holsters normally include a clip that enables the user to releasably attach the holster to a garment or accessory worn upon the body while maintaining a reasonably low profile. In addition to being obvious, most prior art holsters are passive, having no function connected with the actual operation of the phone.

A disadvantage of portable cellular phones is the limited operational battery life. Cellular phones utilize rechargeable batteries as a power source and require recharging after a period of use, the duration depending on the type of “on-board” battery in the phone. In order to extend the operational battery life of a cellular phone, Zurlo et al., in U.S. Pat. No. 5,898,932, disclose a cellular phone comprising a photovoltaic cell integral therewith. The phone includes power connection circuitry that provides electrical connection between the photovoltaic cell and the rechargeable batteries. The circuitry includes means for preventing power transfer from the rechargeable batteries to the solar panel. A problem with the device of Zurlo et al. is that it is necessary to manipulate the orientation of the phone in order to orient the solar panel for maximum insolation. Further, when the phone is housed within the holster, the light incident on the photovoltaic surface is limited to ambient light rather than direct sunlight.

Adams and Parke, in U.S. Pat. No. 5,801,512, disclose a device for providing supplemental photovoltaic energy to communication devices such as cellular phones. The device includes a generally square sheet having a first and second side, the first side of the sheet having a plurality of photovoltaic cells embedded therein and the second side having a double sided adhesive coated thereon for attachment of the sheet to the communication device. The photovoltaic cells provide photoelectric current and are connected to each other in series. The positive and negative leads from the photovoltaic cells are attached to an electrical ribbon wire which protrudes through the second side of the sheet. The end of the ribbon wire is adapted for insertion into a battery plug socket located within the communication device's battery compartment. Additionally, the first side of the sheet houses a light emitting diode (LED) electrically connected between the plurality of photovoltaic cells and the ribbon wire to indicate whether supplemental photoelectric charge is being provided to the communication devices battery. The LED functions as a diode to ensure that the communication device's battery does not discharge when the photovoltaic cells are not in use. In operation, the communication device's battery cover is slid back and the battery plug is removed from its socket. The ribbon wire is inserted and electrically connected into the battery plug socket with an applicator. The battery plug is then reinserted into the socket with the excess ribbon wire folded into the battery compartment and the battery compartment cover is closed against the ribbon wire. The ribbon wire is sufficiently thin so as not to impede the closing of the battery cover. When the photovoltaic cells are in the presence of a light source the battery receives an additional trickle charge resulting in longer use times between charging periods.

The problem with employing solar cells for recharging batteries is that solar cells require a specific loading voltage in order to produce maximum power, while most batteries such as NiCad, Nickel Metal Hydride, and Lithium, demand a varying voltage throughout the charge cycle. There is a continuing need for a simple and efficient battery charging circuit which maintains optimal loading of the solar cell over an order of magnitude of luminescent variations while automatically varying the voltage to the battery for optimum charging.

The prior art devices described above are intended for attachment to a cellular phone. Accordingly, when the cell phone is temporarily housed within a holster during idle periods, as is the normal method for transporting cellular phones, insolation is minimal and the devices are substantially inoperable for their intended use. There remains a need for alternative means for recharging an on-board battery in a cellular phone under field conditions wherein the charger is operable for its intended use even when the cell phone is disposed within a holster.

### SUMMARY

It is an object of the invention to provide a holster for a portable, battery powered cellular phone wherein the holster includes means for employing solar energy to charge the phone's battery when the phone is disposed within the holster.

It is a further object of the invention to provide a holster for a cellular phone meeting the above objective, the holster comprising a photoelectric element and charging circuitry operable for providing electrical connection between the photoelectric element and the battery.

The above objectives are met by a holster operable for attachment to a person for transporting and recharging a battery powered portable communication device that comprises, in combination: (a) a container having a cover with an outer surface having a photovoltaic cell affixed thereto, and a base separably attached to the cover, the cover and base enclosing an externally accessible compartment dimensioned to receive and house a portable communication device such as a cellular phone therewithin; and (b) a clip pivotally attached to the container, the clip being operable for attachment of the holster to the person, thereafter enabling the person to rotationally adjust the orientation of the photovoltaic cell with respect to a source of radiant energy such as the sun in order to optimize the intensity of solar energy incident thereon. The holster further comprises a battery recharging circuit integral therewith, the battery recharging circuit being electrically connected to the photovoltaic cell. The holster includes a phone connector means operable for providing electrical communication between the battery recharging circuit and an on-board battery (i.e., a battery housed within the battery powered communication device).

The features of the invention believed to be novel are set forth with particularity in the appended claims. However the invention itself, both as to organization and method of operation, together with further objects and advantages thereof may be best understood by reference to the following description taken in conjunction with the accompanying drawings in which:

### BRIEF DESCRIPTION OF THE DRAWINGS

FIG. 1 is a perspective view showing a cellular phone disposed within a cellular phone holster in accordance with a first preferred embodiment of the present invention.

FIG. 2 is an exploded perspective view of the cellular phone holster assembly illustrated in FIG. 1.

FIG. 3 is a top perspective view of a holster cover having a photovoltaic cell mounted thereon in accordance with the first preferred embodiment of the invention.

FIG. 4 is a side perspective view of the lower portion of the cellular phone holster of the present invention with the base removed, illustrating the layout of components of the holster that are enclosed by the base.

FIG. 5 is a top perspective view of a separator portion of the holster employed to support a male cellular phone connector and a cellular phone.

FIG. 6 is a perspective view of a flex board shaped to fit within the contour presented by the interior surfaces of the cover and base. The flex board supports a battery, the recharging circuitry (FIGS. 10-13), the LED array, the male cellular phone connector and a female connector.

FIG. 7 is a perspective view of a phone retainer spring.

FIG. 8 is a perspective view of the holster base.

FIG. 9 is a perspective view of a clip adapted to be pivotally mounted on the cellular phone holster and operable for releasable attachment to a garment or accessory worn upon the body.

FIG. 10 is a graphical illustration of the current (I) and voltage (V) output of a typical solar cell.

FIG. 11 shows the configuration of the charger circuit housed within the holster that charges the supplemental battery in relation to the on-board battery charging circuitry.

FIG. 12 shows a circuit diagram illustrating the general features and operation of the recharging circuitry in accordance with a preferred embodiment.

FIG. 13 is a circuit diagram illustrating with particularity a recharging circuit in accordance with a first preferred embodiment of the present invention.

FIG. 14 is a circuit diagram illustrating a recharging circuit in accordance with a second preferred embodiment of the present invention, wherein a negative temperature coefficient resistor Rt is employed to adjust the cell voltage to compensate for temperature variations.

### DESCRIPTION OF THE PREFERRED EMBODIMENTS

The term “holster”, as used herein, means a sheath having an interior compartment adapted to accommodate at least a portion of a cellular phone therewithin. The term “holster”, rather than the term “case”, is used herein to explicitly distinguish the device of the present invention from the outer casing (case) comprising a cellular phone of the type commonly used in the art for mounting, housing and protecting the electrical and mechanical components of a fully operable cellular phone.

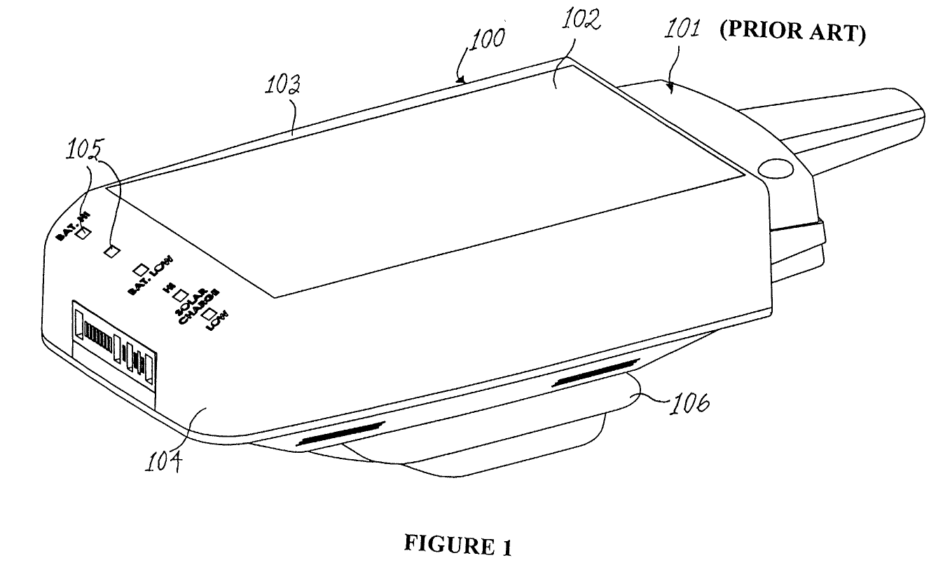

Turning first to FIG. 1, a holster 100 in accordance with a first preferred embodiment of the present invention is illustrated with a cellular phone 101 housed therewithin. The holster 100 includes a photovoltaic cell 102, which may comprise a plurality of photovoltaic elements, affixed to, and substantially coextensive with, an upper surface 103 of a cover 104. The cover 104 preferably includes a plurality of LED's 105 mounted thereon that serve to indicate the status of the charger housed within holster 100 as will be described below. A clip 106, adapted to be releasably attachable to a belt or garment or the like is pivotally mounted on the holster 100.

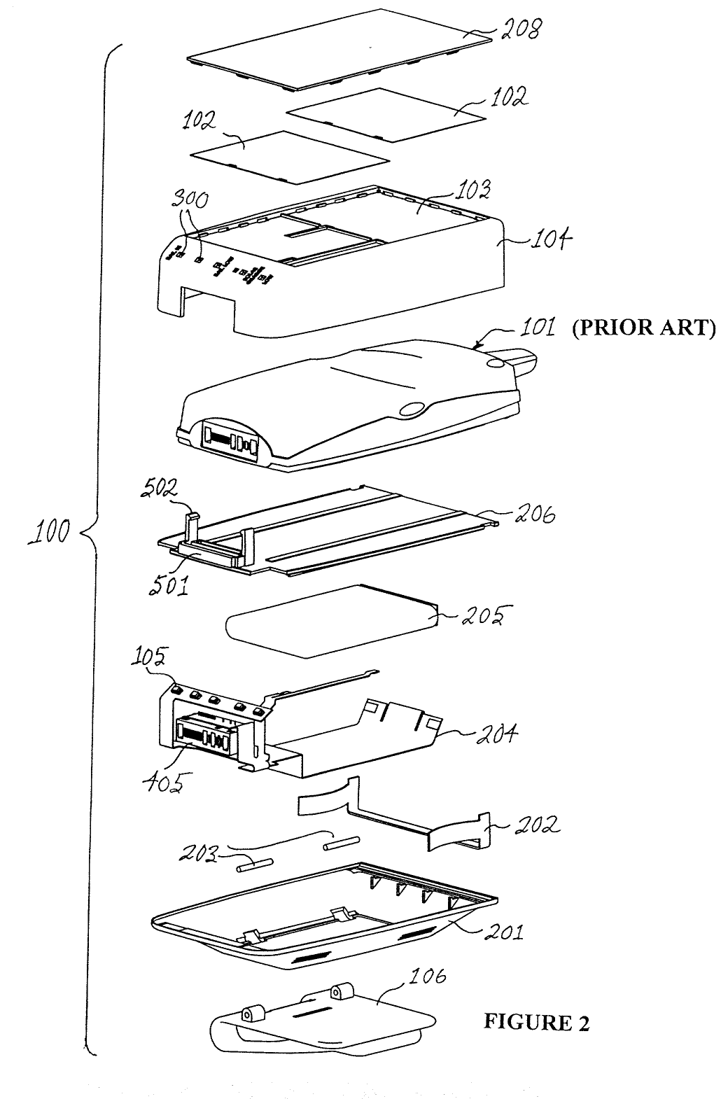

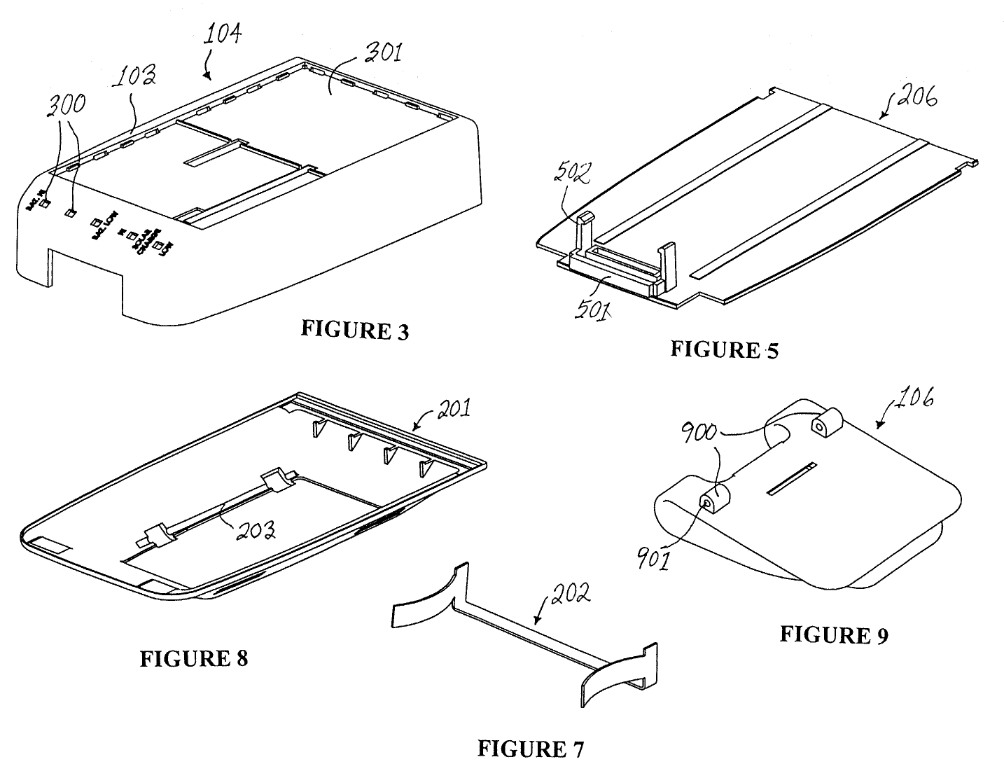

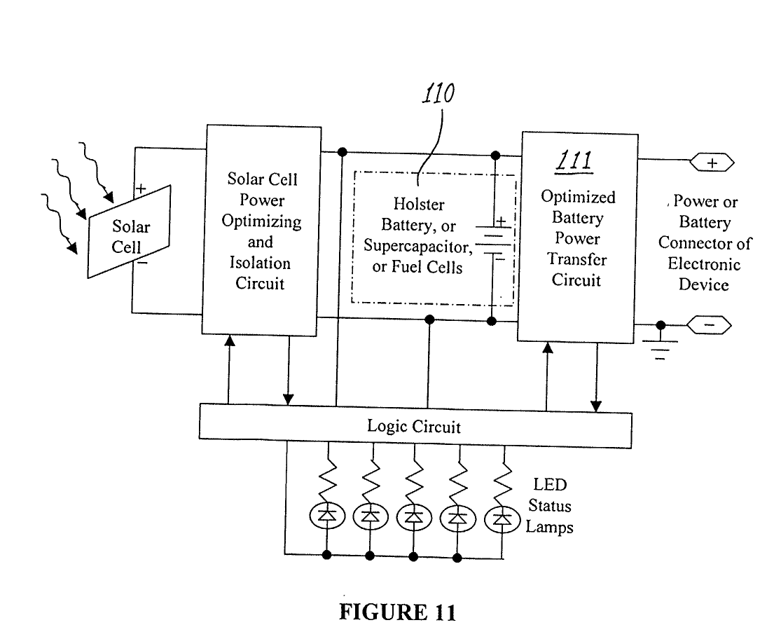

With reference now to FIG. 2, a holster 100 in accordance with a first preferred embodiment of the present invention is illustrated in exploded view. The holster assembly includes a base 201, a clip 106 pivotally attached to the base, a phone retaining clip 202, an LED array 105, a pivot pin 203, a flex circuit board 204 supporting a recharging circuit 110 (FIG. 11), a supplemental battery 205, separator 206, a male cellular phone connector 405, a cover 104 and at least one photovoltaic cell 102 (two photovoltaic cells shown in FIG. 2) affixed to the upper surface 103 of the cover 104. A transparent plate 208 covers and protects the more delicate photovoltaic cell(s) 102. The cover 104, shown in greater detail in FIG. 3, provides protection for the cellular phone 101 (FIGS. 1 and 2) and the recharging circuitry housed within, and integral with, the holster 100 as will be discussed below. The upper surface 103 of the cover has an indented portion 301 dimensioned to snugly accommodate a photovoltaic cell(s) 102 therewithin. The cover 104 preferably includes one or more cutouts 300 dimensioned to accommodate one or more light emitting diodes (LED's) 105 therein. The base 201 (or the cover 104) includes pivot pin attachment means (not visible in FIG. 2) on an outer surface thereof that provides rotational support for pivot pins 203, and the clip 106. The clip 106 is pivotally attached to either the cover 104 or base 201 (not shown in FIGS. 2 or 3) by means of one or more pivot pins 203. The pivotal attachment of the cover or base to the clip enables the wearer to orient the case to provide optimum insolation to the photovoltaic cell under the extant lighting conditions.

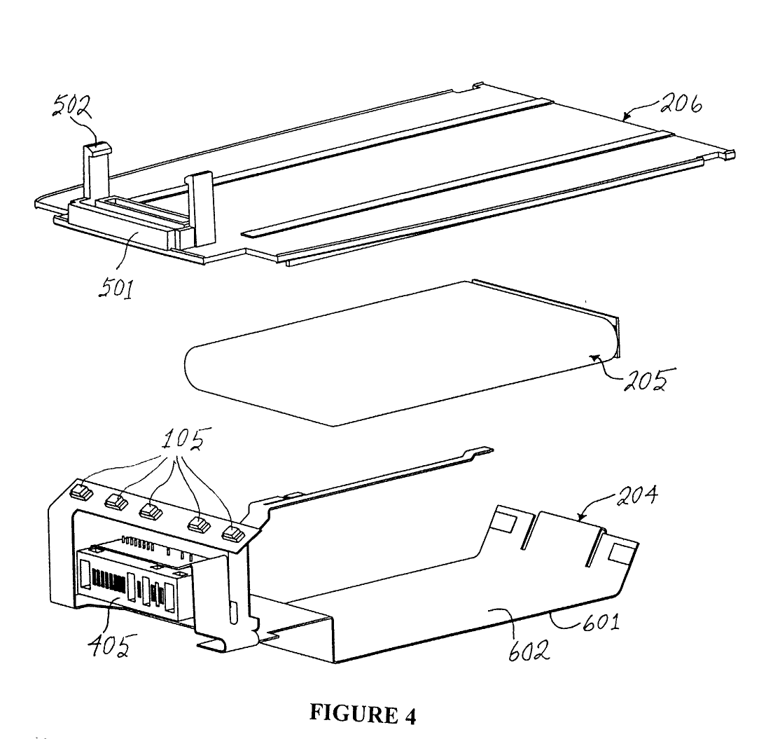

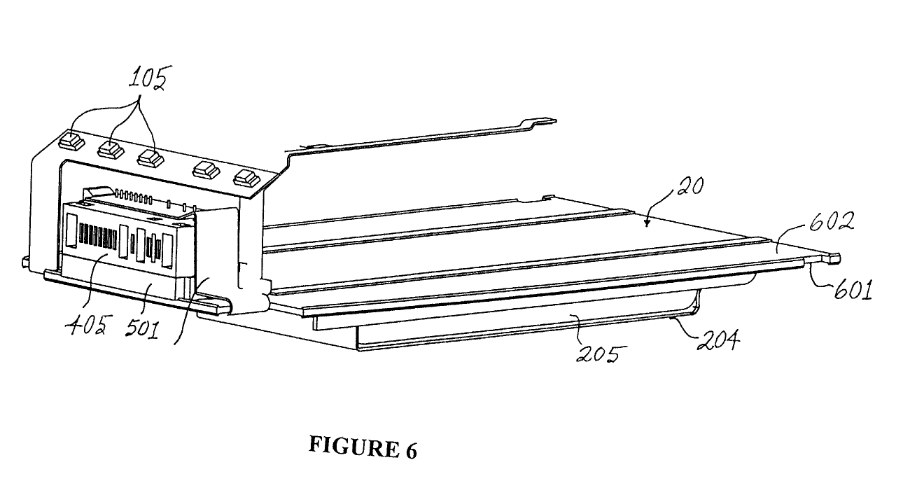

An exploded perspective view illustrating the layout of the components of the holster 100, with the cover 104, base 201, phone retaining spring 202 and clip 106 removed, is shown in FIG. 4. The flex circuit board 204, shown in the enlarged, exploded perspective view of the support plate/flex circuit subassembly in FIGS. 6, is sufficiently flexible to conform to the contour of the base 201 and cover 104 adjacent a bottom surface 601 thereof and a battery 205 adjacent an upper surface 602 thereof. A female connector 405 attached to the flex circuit board 204 provides means for electrically connecting the photovoltaic cell 102 to the recharging circuitry as will be discussed below. An electrical feedthrough 501 on the support plate 206 receives and supports the female connector 405 which provides releasable means for electrically connecting a cell phone's on-board battery to the recharging circuitry mounted on the flex circuit board 204. A pair of elastically deformable clips 502 firmly attach the female connector 405 to the support plate 206. A plurality of light emitting diodes 105 or similar display devices, are in electrical communication with the recharging circuit and indicate the status thereof. The LED's are disposed on the flex circuit board to align with respective LED cutouts 300 on the cover 104. The separator 206, shown in perspective view in FIGS. 2,4 and 6, serves to physically separate the battery 205 from a cell phone 101 disposed within the holster 100, and support the phone retaining spring 202, shown in perspective view in FIG. 7. The base 201 comprising the case 100 is shown in perspective view in FIG. 8. The belt clip 106, shown in perspective view in FIG. 9, includes a strut 900 having an axial bore 901 coextensive with the length of the strut. The axial bore 901 of belt clip 106 is dimensioned to snugly accommodate the pivot pin(s) 203 therein.

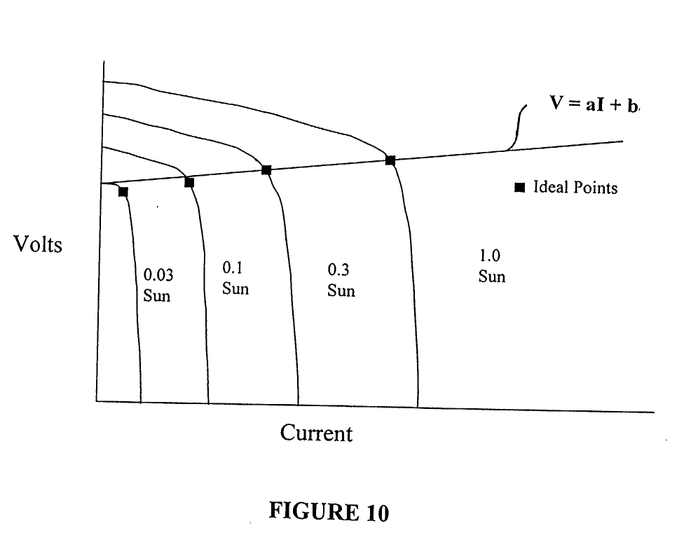

It is instructive to the understanding of the recharger circuit comprising the holster 100 in accordance with the present invention, and described hereinbelow, to consider the relationship between the voltage and current output of a typical photovoltaic cell as illustrated in FIG. 10. The optimum power output for incident light intensity varies in a pattern that produces a curve that can be approximated by a straign line between 0.1 sun and 1.0 in accordance with the straight line equation: V=aI+b. For Lithium ion batteries, the slope (a) of the line approaches zero so as to maintain a constant voltage on the solar cell that is substantially independent of illuminence.

Most battery charging algorithms today implement one or more stages. In each stage, the battery is charged at a limited rate of current to a given voltage set point. In the case of Lithium chemistry, a single stage “voltage limited, current limited” charge algorithm is capable of recharging the battery to 100% of full capacity. Very high efficiency, high frequency DC to DC, boost or buck converter chips can be utilized in a simple low component count charging circuit. However the problem is that these DC to DC converters are designed to produce a fixed voltage output, and will draw as much current from the cell as is necessary to maintain the set voltage. As the battery voltage changes due to state of charge of the battery and variations in power loading, the current drawn from the solar cell (photovoltaic cell) immediately becomes non-ideal for extracting maximum power from the cell.

As shown in FIG. 11, power is transferred from the secondary power storage device 110 within the holster to the battery housed within the electronic device (cell phone, PDA, etc.). The secondary power storage device 110 is most preferably a battery, as shown at 105 in FIG. 2, or it could be a super capacitor, fuel cell, etc. Power transfer to the electronic device (cell phone, PDA, etc.) is accomplished using conventional circuits 111 well know in prior art for recharging batteries, or novel circuits optimized for the specific holstered electronic device as will be discussed below. In one such novel embodiment for a cell phone, the holster battery is simply boosted to an acceptable voltage that is optimally processed by the built in battery management circuits of the cell phone.

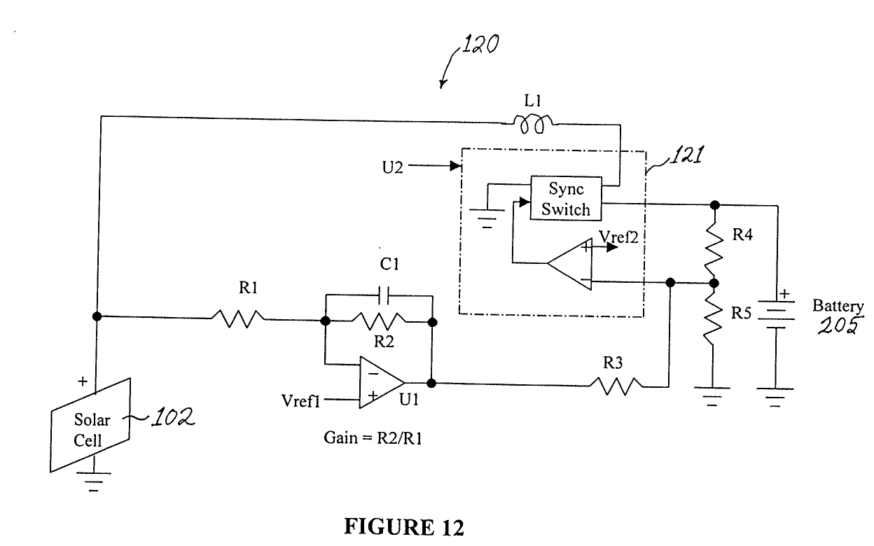

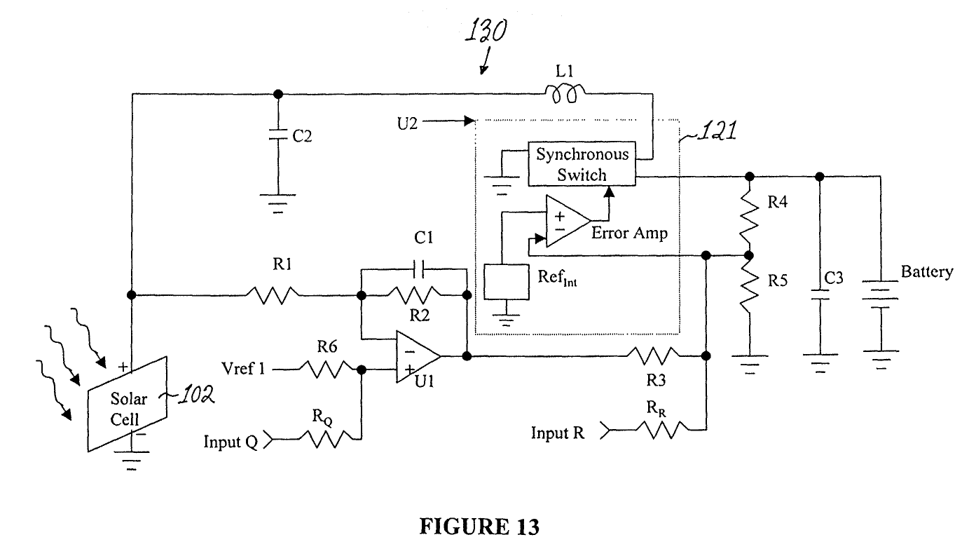

With reference again to FIG. 10, it is clear that when more than the optimum current is drawn from solar cell 102, the voltage output of the solar cell rapidly drops to an unacceptable level that provides less than optimum power transfer to the secondary battery 102 housed within the holster. The circuit 120 of FIG. 12 overcomes this limitation by comparing the solar cell voltage to a fixed reference voltage and feeding forward a signal to the converter 121 which adjusts the output voltage set point to automatically return the input current to the optimum solar cell value for any given solar illuminance. This “feed forward” technique can be implemented with any desired gain to match the solar cell's approximated optimum power point curve as depicted in FIG. 10. Additionally, with a “Rail to Rail” output, or other low output voltage limited operational amplifier, along with the correct resistor component values, as shown in FIG. 12, the circuit 120 will automatically limit the charging voltage to the battery. The preferred embodiment for use with a single 2 VDC solar cell is summarized in FIG. 120. Given that Ref_{Int}, the internal voltage reference of the boost converter, is 1.24 VDC, the following exemplary component values may be used: C1: 47 picofarads, C2: 33 microfarads, C3: 100 microfarads, L1: 3.3 microHenries, R1: 100 Kohms, R2: Not Installed, R3: 331 Kohm, R4: 270 Kohm, R5: 171 Kohm, R6: Not Installed—for a gain of >10,000, R_{Q} Not Installed, R_{R}: Not Installed. The voltage limit set by circuit 120 is as accurate as the on-board voltage reference of the DC to DC converter chip and the precision of the external components, and is, therefore, usually sufficient to guarantee optimum battery charging. In one embodiment, a lithium ion battery is automatically charged to exactly 4.2 VDC.

With reference to the recharging circuit set forth in FIG. 130, a small correction can be added to either the solar cell input voltage reference point (Input Q), or to the output voltage (Input R) to optimize the charging, thereby compensating for temperature, aging, or other effects. One such embodiment employs a microprocessor to monitor solar cell power and adjust, in real-time, the input q for maximum power to the battery, and also to fine tune the maximum battery voltage for temperature and aging effects. In one experiment, using a single, three-junction solar cell that produces 2.5 VDC (open circuit), a reference voltage (Vref) of 2.0 VDC, and a gain of infinity (pure integrator) was found to optimize the charging circuit to within 5% of ideal over the range of 0.1 sun to 1.0 sun, without any further adjustments at an ambient temperature of 70 degrees Fahrenheit.

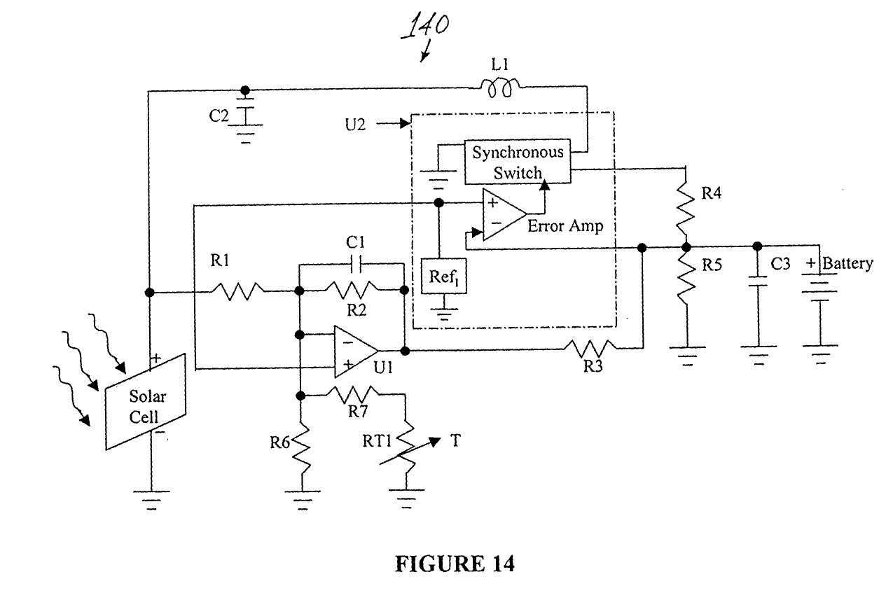

A modified version of circuit 130 is shown at numeral 140 in FIG. 14. The modified recharging circuit 140 includes a negative temperature coefficient resistor RT1 to make small adjustments in the cell voltage to compensate for temperature variations. FIG. 14 also illustrates a method of using the DC/DC converter's onboard reference as a voltage reference on the non-inverting input of operational amplifier U1 for optimizing the solar cell load.

Prior art battery recharging circuits commonly employ a plurality of low voltage (˜0.5 VDC) solar cells connected in series to achieve sufficient voltage to charge a single lithium or multiple nicad battery pack that requires a maximum voltage of 4 to 5 VDC. Circuit 110, in accordance with one aspect of the present invention, reduces the number of solar cells to two or three, thereby reducing assembly cost and loss of efficiency due to “shingling” which wastes cell area at the overlapping junctions. It also achieves the increase in efficiency as described above by continually optimizing the cell current draw. In one test employing a 95% efficient, 1 MHz boost converter chip with a single 2.5 VDC (multi-junction) solar cell, resulted in an average conversion efficiency from cell to battery of 93%. By way of comparison, shingling of multiple 2.5 volt solar cells resulted in an average efficiency of about 83% and shingling of 0.5 volt (mono-junction) cells resulted in about 76% overall efficiency. The circuit automatically reduces the battery charging current when the solar illuminance is low, and restores full charging current when illuminance is high. The circuits 110, 120 and 130 may also be employed in applications requiring the generation of a fixed or variable voltage or current supply by maintaining the peak loading point of the solar cell for varying conditions of illuminance.

While particular embodiments of the holster of the present invention have been illustrated and described, it would be obvious to those skilled in the art that various other changes and modifications can be made without departing from the spirit and scope of the invention. For example, while the holster of the present invention has been described for housing and recharging a cellular phone, the holster and charging circuitry may be adapted to contain and recharge the on-board battery of other electronic devices such as flashlights, radios, computers and cameras. It is therefore intended to cover in the appended claims all such changes and modifications that are within the scope of this invention.

What we claim is:

1. A holster operable for attachment to a person for transporting and recharging a battery powered portable communication device comprising:
(a) a container having a cover with an outer surface having a photovoltaic cell affixed thereto, and a base separably attached to said cover, said cover and said base enclosing an externally accessible compartment dimensioned to receive and house a portable communication device therewithin;
(b) a clip pivotally attached to said container, said clip being operable for attachment of said holster to the person, thereafter enabling the person to rotationally adjust the orientation of said photovoltaic cell with respect to a source of radiant energy.

2. The holster of claim 1 further comprising a battery recharging circuit integral therewith, said battery recharging circuit being electrically connected to said photovoltaic cell.

3. A holster in accordance with claim 2 further comprising phone connector means operable for providing electrical communication between said battery recharging circuit and a rechargeable battery housed within said battery powered communication device.

4. A holster in accordance with claim 3 further comprising a visual connection indicator means operable for verifying electrical connection between said battery recharging circuit and the rechargeable battery housed within the communication device.

5. A holster in accordance with claim 4 wherein said visual connection indicator means is a light emitting diode.

6. A holster in accordance with claim 4 further comprising a charging status indicator means operable for visually verifying that said battery recharging circuit is recharging the rechargeable battery housed within the communication device.

7. A holster in accordance with claim 6 wherein said charging status indicator means is a light emitting diode.

8. A holster operable for attachment to a person for transporting and recharging a battery in a battery powered electronic device comprising:
(a) a container having a cover with an outer surface having a photovoltaic cell affixed thereto, and a base separably attached to said cover, said cover and said base enclosing an externally accessible compartment dimensioned to receive and house the electronic device therewithin;
(b) a clip pivotally attached to said container, said clip being operable for attachment of said holster to the person, thereafter enabling the person to rotationally adjust the orientation of said photovoltaic cell with respect to a source of radiant energy.

9. The holster of claim 8 further comprising a battery recharging circuit integral therewith, said battery recharging circuit being electrically connected to said photovoltaic cell.

10. A holster in accordance with claim 9 further comprising phone connector means operable for providing electrical communication between said battery recharging circuit and a rechargeable battery housed within said battery powered electronic device.

11. A holster in accordance with claim 10 further comprising a visual connection indicator means operable for verifying electrical connection between said battery recharging circuit and the rechargeable battery housed within the electronic device.

12. A holster in accordance with claim 11 wherein said visual connection indicator means is a light emitting diode.

13. A holster in accordance with claim 11 further comprising a charging status indicator means operable for visually verifying that said battery recharging circuit is recharging the rechargeable battery housed within the electronic device.

14. A holster in accordance with claim 13 wherein said charging status indicator means is a light emitting diode.

15. A solar powered battery recharging device operable for receiving light from an external source of light and converting energy in the light into electrical energy, thereafter storing at least a portion of said electrical energy in a rechargeable battery, the device comprising:
(a) a photovoltaic cell having a current output, a voltage output and a power output defined by the product of the voltage output of the cell and the current output of the cell, the power output of the cell having a maximum value for a particular illuminance; and
(b) an electrical circuit having a charging current output and an input in electrical connection with said voltage output of said photovoltaic cell and charging current control means operable for comparing said cell output voltage to a fixed reference voltage and feeding forward a signal to a converter which adjusts an output voltage set point to automatically return said current output of said cell to the optimum power output value for said cell.

16. A solar powered battery recharging device in accordance with claim 15 further comprising a supplemental battery in electrical connection with said charging current output of said electrical circuit.

17. A solar powered battery recharging device operable for receiving light from an external source of light and converting energy in the light into electrical energy, thereafter storing at least a portion of said electrical energy in a rechargeable battery, the device comprising:
(a) A holster operable for attachment to a person for transporting and recharging a battery powered portable communication device, the holster comprising:
(i) a container having a cover with an outer surface having a photovoltaic cell affixed thereto, and a base separably attached to said cover, said cover and said base enclosing an externally accessible compartment dimensioned to receive and house a portable communication device therewithin;
(ii) a clip pivotally attached to said container, said clip being operable for attachment of said holster to the person, thereafter enabling the person to rotationally adjust the orientation of said photovoltaic cell with respect to a source of radiant energy; and
(b) a photovoltaic cell affixed to said holster and having a current output, a voltage output and a power output defined by the product of the voltage output of the cell and the current output of the cell, the power output of the cell having a maximum value for a particular illuminance and an electrical circuit having a charging current output and an input in electrical connection with said voltage output of said photovoltaic cell and charging current control means operable for comparing said cell output voltage to a fixed reference voltage and feeding forward a signal to a converter which adjusts an output voltage set point to automatically return said current output of said cell to the optimum power output value for said cell.
